(19) United States
(12) Patent Application Publication
(10) Pub. No.: US 2008/0261444 A1
(43) Pub. Date: Oct. 23, 2008

(54) Co-Axial Plug for a Co-Axial Plug-in-Connector

(75) Inventors: Bernd Rosenberger, Tittmoning (DE); Christian Entsfellner, Fridolfing (DE)

Correspondence Address: LOWE HAUPTMAN HAM & BERNER, LLP, 1700 DIAGONAL ROAD, SUITE 300, ALEXANDRIA, VA, 22314, US

(73) Assignee: ROSENBERGER HOCHFREQUENZTECHNIK GMBH & CO. KG, Fridolfing (DE)

(21) Appl. No.: 11/569,019

(22) PCT Filed: May 11, 2005
(86) PCT No.: PCT/EP2005/005091

§ 371 Date: Nov. 13, 2006

(30) Foreign Application Priority Data
May 17, 2004 (DE) 20 2004 007 909.7

(51) Int. Cl. H01R 9/05

(52) U.S. Cl. 439/578

(57) ABSTRACT

A housing coupler for a coaxial plug-in connector, particularly of the N-type, has a cylindrical housing (1) that forms an outer conductor and (2) has coaxial cable-side and plug-side ends. A groove on an inner wall of the housing (1) is next to the plug-side end, (2) extends in an annular manner and (3) forms a detent edge.

The present invention relates to a bulkhead socket for a co-axial plug and socket connector, particularly of the N-type, having a cylindrical shell which forms an outer conductor and has a co-axial cable end and a mating end, as defined in the preamble to claim 1. The invention also relates to a coaxial plug and socket connector having a co-axial plug and a bulkhead socket, in particular of the N type, as defined in the preamble to claim 4.

Co-axial plug and socket connectors comprise a co-axial plug and a co-axial bulkhead socket which, when plugged together and connected to one another, produce co-axial plug-in contact. To allow a plug and socket to be connected in the case of co-axial plug and socket connectors of the so-called N type, the socket has a thread on its outer circumference. The plug is fitted with a union nut which likewise has a thread, on its inner circumference. To connect an N plug and an N socket, they are plugged together and the union nut of the N plug is screwed, by its inside thread, onto the outside thread on the N socket. The connection of co-axial plug and socket connectors of the N type in this way has long been known and provides a good and secure HF contact between the plug and socket. However, it is often felt to be a disadvantage that a screwing operation which takes a relatively large amount of manual effort and a relatively long time has to be performed to connect the plug and socket. In applications where, for example, a large number of co-axial connections have to be made between plugs and sockets, the manual effort and time spent adds up to a considerable total.

The object underlying the invention is to simplify a bulkhead socket or a co-axial plug and socket connector in respect of the connecting and disconnecting operations, the intention being for reliability in operation to be preserved in full with regard to the transmission of HF signals.

This object is achieved in accordance with the invention by a bulkhead socket of the above-mentioned kind having the features which are characterised in claim 1 and by a co-axial plug and socket connector of the above-mentioned kind having the features which are characterised in claim 4. Advantageous embodiments of the invention are defined in the respective sets of further claims.

In a bulkhead socket of the above-mentioned kind, provision is made, in accordance with the invention, for a groove which extends round in an annular shape to be formed in an inside wall of the shell, adjacent the mating end.

This has the advantage that a co-axial plug having an elastically resilient latching part which fits into the groove in the shell can be fastened to the bulkhead socket.

In a preferred embodiment, a mating end of the groove, which mating end forms the latching edge, is spaced 2.8 mm to 3 mm, and in particular 2.9 mm, away from the mating end of the bulkhead socket.

The shell usefully has on its outer circumference a thread to engage with an inside thread in a union nut belonging to a conventional co-axial plug. In this way, the bulkhead socket can, if desired, also be connected to a standardised conventional co-axial plug which has screwed fastening means.

In a co-axial plug and socket connector of the above kind, provision is made in accordance with the invention for the bulkhead socket to be formed as described above.

This has the advantage that the co-axial plug-in connection can be connected and disconnected again easily, quickly and with an assurance of reliable operation without screwed connections having to be operated.

In a preferred embodiment, the co-axial plug comprises a cylindrical outer-conductor part of its shell which forms an outer conductor and which has a mating end and a co-axial cable end, a latching sleeve being provided which fits round the outer-conductor part of the shell and which is axially displaceable relative to the outer-conductor part of the shell. A spring is provided which is supported by one of its ends against the outer-conductor part of the shell and by its other end against the latching sleeve, in such a way that the latching sleeve is pre-loaded in the direction of the co-axial cable end of the outer-conductor part of the shell. The latching sleeve to be formed to have axial slots at its mating end so that elastically resilient latching tongues are formed, said latching tongues each having, at their mating ends, a latching edge which extends upwards in a radially outward direction, to latch onto the latching edge of the groove in the bulkhead socket. Also provided is an unlocking sleeve which surrounds the latching sleeve and is displaceable axially relative to the latching sleeve, the latching sleeve having a ramp which extends upwards in a radially outward direction and which slopes up in the direction of the co-axial cable end, which ramp co-operates with a correspondingly bevelled groove in an inside face of the unlocking sleeve in such a way that displacement of the unlocking sleeve relative to the latching sleeve in the direction of the co-axial cable end causes the latching tongues of the latching sleeve to bend inwards radially.

A stop for the latching sleeve is usefully formed at the co-axial cable end of the outer-conductor part of the shell, which stop sets a limit for axial movement of the latching sleeve in the direction of the co-axial cable end of the outer-conductor part of the shell.

The invention will be explained in detail below by reference to the drawings. In the drawings:

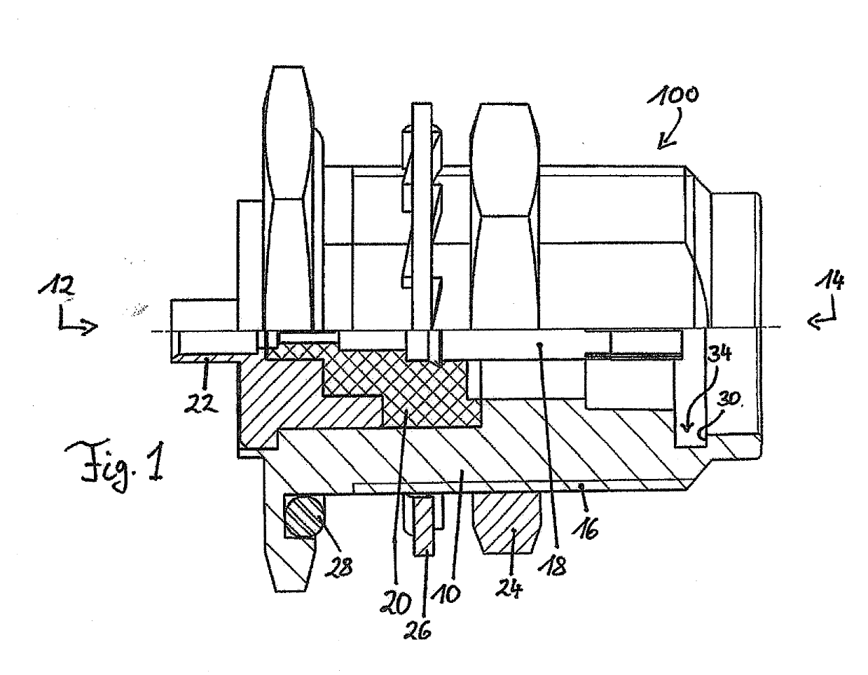

FIG. 1 is a side view, partly in section, of a preferred embodiment of bulkhead socket according to the invention.

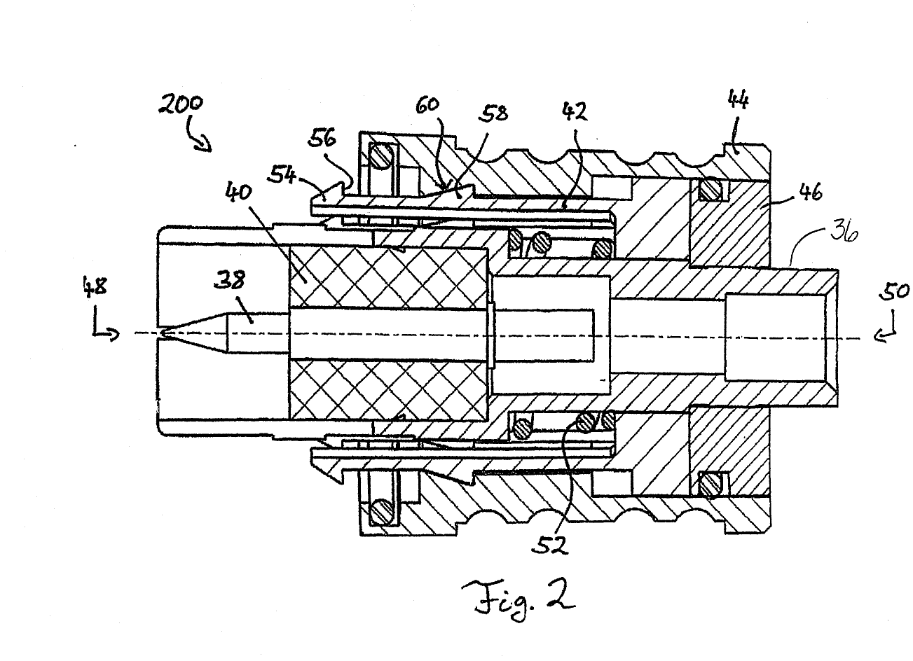

FIG. 2 is a view in section of a co-axial plug which fits the bulkhead socket shown in FIG. 1, and

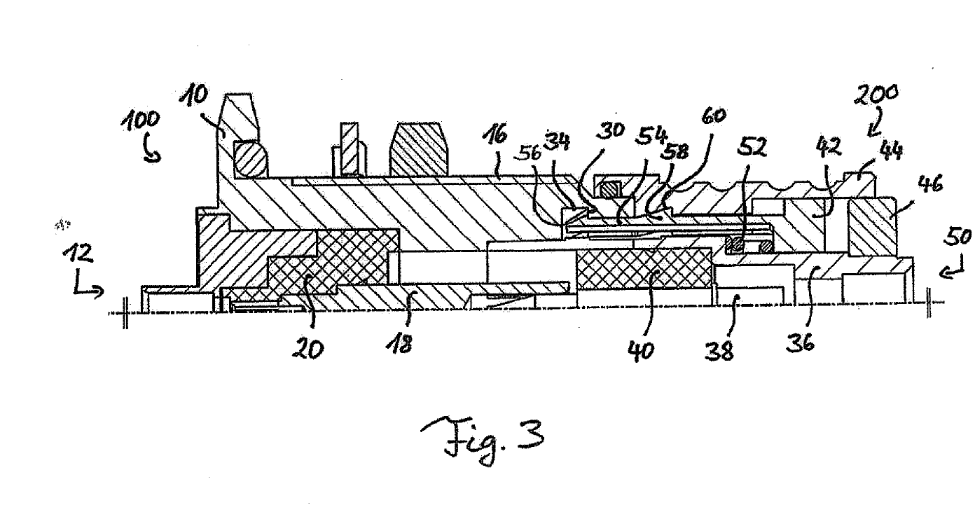

FIG. 3 is a view in section of the bulkhead socket of FIG. 1 and the co-axial plug of FIG. 2, in the plugged-together state.

FIG. 1 shows a preferred embodiment of a bulkhead socket 100, formed in accordance with the invention, of the N type for a co-axial plug and socket connector, having a cylindrical shell 10 which forms an outer conductor and which has a co-axial cable end 12, a mating end 14, and, on its outer circumference, an outside thread 16. The bulkhead socket 100 also comprises a centre conductor 18, an insulating part 20, a female solder connection 22, a hexagon nut 24, a shakeproof washer 26 and an O-ring 28.

This N-type bulkhead socket 100 is of a standardised design, except as follows: at the mating end 14, there is formed in the inner circumference of the shell 10, by means of a groove 34 which extends round in an annular shape in an inside face of the shell 10, a latching edge 30. The groove 34 is formed by stock-removing machining of the standardised inner circumference of the shell 10, at the mating end 14. This configuration of the inner circumference of the shell 10 at the mating end 14, which is non-standard, is of a form such that operation is not adversely affected in any way when a conventional co-axial plug having a union nut is plugged in, which means that even a standardised N-type co-axial plug having an internally threaded union nut can be fastened to a bulkhead socket as shown in FIG. 1.

Because of the design according to the invention of the bulkhead socket 100, it is also possible to plug in a specially designed co-axial plug of a quick-action fastening type. This special co-axial plug has a latching element which engages behind the latching edge 34 and, in co-operation with the latching edge 34, makes a mechanically firm connection between the bulkhead socket and the co-axial plug.

A specially designed co-axial plug 200 of this kind is shown by way of example in FIG. 2 and comprises a cylindrical outer-conductor part 36 of the shell which forms an outer conductor, a centre conductor 38, an insulating part 40, a latching sleeve 42, an unlocking sleeve 44 and a compression ring 46. The outer-conductor part 36 of the shell has a mating end 48 and a co-axial cable end 50. The latching sleeve 42 fits round the outer-conductor part 36 of the shell. A spring 52 is provided which is supported by one of its ends against the outer-conductor part 36 of the shell and by other end against the latching sleeve 42, in such a way that the latching sleeve 42 is pre-loaded in the direction of the co-axial cable end 50 of the outer-conductor part 36 of the shell. At the co-axial cable end 50 of the outer-conductor part 36 of the shell, there is formed a stop for the latching sleeve 42 in the form of the compression ring 46, which sets a limit for axial movement of the latching sleeve 42 in the direction of the co-axial cable end 50 of the outer-conductor part 36 of the shell. At its mating end 48, the latching sleeve 42 is formed to have axial slots, thus producing elastically resilient latching tongues 54. At their mating ends, these latching tongues 54 each have a latching edge 56 which extends upwards in a radially outward direction. The unlocking sleeve 44 surrounds the latching sleeve 42 and is axially displaceable relative to the latching sleeve 42. The latching sleeve 42 has a ramp 58 which extends upwards in a radially outward direction and which slopes up in the direction of the co-axial cable end 50, which ramp 58 co-operates with a correspondingly bevelled groove 60 in an inside face of the unlocking sleeve 44 in such a way that displacement of the unlocking sleeve 44 relative to the latching sleeve 42 in the direction of the co-axial cable end 50 causes the latching tongues 54 of the latching sleeve 42 to be bent radially inwards.

FIG. 3 shows the way in which the locking mechanism between the bulkhead socket 100 and the co-axial plug 200 operates, parts which perform the same functions being denoted by the same reference numerals as in FIGS. 1 and 2, for which reason reference should be made to the above description of FIGS. 1 and 2 for an explanation of them. In the plugged-in state, the latching tongues 54 having the latching edges 56 engage behind the latching edge 34 of the groove 34. This produces a locking retention between the bulkhead socket 100 and the co-axial plug 200 without a screwed connection having to be made for this purpose. Instead, the co-axial plug 200 merely has to be pushed into the bulkhead socket 100. Because the latching edge 56 is of a ramp-like configuration, it automatically slides past the latching edge 30, the latching tongues 44 being bent radially inwards elastically, and into the groove 34. The unlocking sleeve 44 is used to release this latched mechanical connection again. For this purpose, the unlocking sleeve 44 is displaced axially, relative to the latching sleeve 42, or in other words relative to the outer-conductor part 36 of the shell, in the direction of the co-axial cable end 50 of the co-axial plug 200. Because of this, the bevelled groove 60 slides over the ramp 58 on the latching sleeve 42, whereby the latching tongues 54 are bent radially inwards. This causes the latching edge 56 to be freed from its engagement with the latching nose 30, thus enabling the co-axial plug 200 to be withdrawn from the bulkhead socket 100.

The co-axial plug 200 which fits the bulkhead socket 100 formed in accordance with the invention is formed as follows:

Co-axial plug 200 for a co-axial plug and socket connector, particularly of the N type, wherein the co-axial plug 200 comprises a cylindrical outer-conductor part 36 of its shell which forms an outer conductor and which has a mating end 48 and a co-axial cable end 50, characterised in that a latching sleeve 42 is provided which fits round the outer-conductor part 36 of the shell and which is axially displaceable relative to the outer-conductor part 36 of the shell, in that a spring 52 is provided which is supported by one of its ends against the outer-conductor part 36 of the shell and by its other end against the latching sleeve 42, in such a way that the latching sleeve 42 is pre-loaded in the direction of the co-axial cable end 50 of the outer-conductor part 36 of the shell, in that the latching sleeve 42 is formed to have axial slots at its mating end 48 so that elastically resilient latching tongues 54 are formed, said latching tongues 54 each having, at their mating ends, a latching edge 56 which extends upwards in a radially outward direction, and in that an unlocking sleeve 44 is provided which surrounds the latching sleeve 42 and is displaceable axially relative to the latching sleeve 42, the latching sleeve 42 having a ramp 58 which extends upwards in a radially outward direction and which slopes up in the direction of the co-axial cable end 50, which ramp 58 co-operates with a correspondingly bevelled groove 60 in an inside face of the unlocking sleeve 44 in such a way that displacement of the unlocking sleeve 44 relative to the latching sleeve 42 in the direction of the co-axial cable end 50 causes the latching tongues 54 of the latching sleeve 42 to bend inwards radially.

Co-axial plug and socket connector 200 as described in the previous paragraph, characterised in that there is formed, at the co-axial cable end 50 of the outer-conductor part 36 of the shell, a stop 46 for the latching sleeve 42, which stop 46 sets a limit for axial movement of the latching sleeve 42 in the direction of the co-axial cable end 50 of the outer-conductor part 36 of the shell.

1.-6. (canceled)

7. A bulkhead socket for a co-axial plug and socket connector, the bulkhead socket comprising an outer conductor including a cylindrical shell having a co-axial cable end and a mating end, the shell having an inside wall adjacent the mating end, the inside wall including a groove that extends around in an annular shape and includes a lip having a latching edge for a surface of the socket connector.

8. Bulkhead socket according to claim 7, wherein the mating end of the groove includes the latching edge and is spaced 2.8 mm to 3 mm away from the mating end of the bulkhead socket.

9. Bulkhead socket according to claim 7, wherein the mating end of the groove includes the latching edge and is spaced 2.9 mm away from the mating end of the bulkhead socket.

10. Bulkhead socket according to claim 7, wherein the socket connector is of the N-type.

11. Bulkhead socket according to claim 7, wherein the shell has on its outer circumference a thread to engage an inside thread in a union nut of a conventional co-axial plug.

12. Co-axial plug and socket connector having a co-axial plug and a bulkhead socket, wherein the bulkhead socket is in accordance with claim 7.

13. The plug and socket connector of claim 12 wherein the socket is of the N type.

14. Co-axial plug and socket connector according to claim 13 wherein the co-axial plug comprises a cylindrical outer-conductor part of its shell which comprises an outer conductor and which has a mating end and a co-axial cable end, a latching sleeve fitting around the outer-conductor part of the shell and being axially displaceable relative to the outer-conductor part of the shell, a spring supported by one of its ends against the outer-conductor part of the shell and by its other end against the latching sleeve in such a way that the latching sleeve is pre-loaded in the direction of the co-axial cable end of the outer-conductor part of the shell, the latching sleeve having elastically resilient latching tongues formed by axial slots at its mating end, said latching tongues each having, at their mating ends, a latching edge which extends upwards in a radially outward direction to latch onto the latching edge of the groove in the bulkhead socket, an unlocking sleeve surrounding the latching sleeve, the unlocking sleeve being displaceable axially relative to the latching sleeve, the latching sleeve having a ramp which (a) extends upwardly in a radial outward direction and (b) slopes up toward the co-axial cable end, the ramp co-operating with a correspondingly bevelled groove in an inside face of the unlocking sleeve in such a way that displacement of the unlocking sleeve relative to the latching sleeve toward the co-axial cable end causes the latching tongues of the latching sleeve to bend radially inwards.

15. The co-axial plug and socket connector according to claim 14, further including a stop for the latching sleeve at the co-axial cable end of the outer-conductor part of the shell, the stop setting a limit for axial movement of the latching sleeve toward the co-axial cable end of the outer-conductor part of the shell.

16. Co-axial plug and socket connector according to claim 12 wherein the co-axial plug comprises a cylindrical outer-conductor part of its shell which comprises an outer conductor and has a mating end and a co-axial cable end, a latching sleeve fitting around the outer-conductor part of the shell and being axially displaceable relative to the outer-conductor part of the shell, a spring supported by one of its ends against the outer-conductor part of the shell and by its other end against the latching sleeve, in such a way that the latching sleeve is pre-loaded in the direction of the co-axial cable end of the outer-conductor part of the shell, the latching sleeve having elastically resilient latching tongues formed by axial slots at its mating end, said latching tongues each having, at their mating ends, a latching edge which extends upwards in a radially outward direction to latch onto the latching edge of the groove in the bulkhead socket, an unlocking sleeve surrounding the latching sleeve, the unlocking sleeve being displaceable axially relative to the latching sleeve, the latching sleeve having a ramp which (a) extends upwardly in a radial outward direction and (b) slopes up toward the co-axial cable end, the ramp co-operating with a correspondingly bevelled groove in an inside face of the unlocking sleeve in such a way that displacement of the unlocking sleeve relative to the latching sleeve toward the co-axial cable end causes the latching tongues of the latching sleeve to bend radially inwards.

17. The co-axial plug and socket connector according to claim 16, further including a stop for the latching sleeve at the co-axial cable end of the outer-conductor part of the shell, the stop setting a limit for axial movement of the latching sleeve toward the co-axial cable end of the outer-conductor part of the shell.
